(19) United States
(12) Patent Application Publication
(10) Pub. No.: US 2004/0143516 A1
(43) Pub. Date: Jul. 22, 2004

(54) System for allowing vendors to manage product information in a database system

(76) Inventors: Neil A. Hastie, Glenview, IL (US); Eric Lane, Woodridge, IL (US); Michael J. Weeder, Winfield, IL (US); Thomas Greenhaw, Glenview, IL (US)

Correspondence Address: BRINKS HOFER GILSON & LIONE, P.O. BOX 10395, CHICAGO, IL, 60610, US

(21) Appl. No.: 10/438,742

(22) Filed: May 15, 2003

Related U.S. Application Data
(60) Provisional application No. 60/391,558, filed on Jun. 25, 2002.

(51) Int. Cl. G06F 17/60

(52) U.S. Cl. 705/27

(57) ABSTRACT

A data management system is disclosed that includes a database and one or more interfaces to allow access the database. The database stores data such as data describing a product. Vendors, such as manufacturers and representatives of the manufacturers, view and are able to enter and maintain the product information data. Buyers, such as wholesalers, distributors and retailers, may utilize the data in the database to provide information to customers about the products it sells. To provide the customers with the information, the data may be used to create catalogs or to provide the product information on-line, such as through the Internet.

### RELATED APPLICATIONS

This application claims priority as a continuation to the earlier filed provisional U.S. patent application Ser. No. 60/391,558, filed Jun. 25, 2002, which is incorporated by reference herein.

### FIELD OF THE INVENTION

The present invention generally relates to the management of data contained in databases, and more particularly relates to a system for allowing a plurality of vendors to manage data, such as product information data, in the database.

### BACKGROUND

Known suppliers, wholesales, distributors and retailers, referred to herein as buyers, currently expend much time, money and resources to record and maintain information from manufacturers about the products the buyer buys and sells to its customers. The product information is maintained on paper documents and in electronic databases. A great stakeholder in the presentation, accuracy and timeliness of product information, however, may be the manufacturer and the manufacturer's representatives, collectively referred to herein as vendors.

Moreover, real-time product information sharing between the vendors and the buyers could be important, as is minimizing mistakes and omissions to the product information. Many of today's vendors want to relay on an electronic data interchange with buyers to share information about the descriptions, supply chain and inventory of its products. For years, industry trade associations have attempted to implement electronic commerce solutions for the benefit of the vendors and buyers. These efforts, however, have met with limited success. Some reasons for the limited success include the high cost of electronic data interchange, the error-prone manual entry of the information, the complexity of those transactions and the lack of consensus on transaction standards and industry-specific product descriptor databases.

There is a need, therefore, for an improved data management system that addresses some or all of these problems.

### BRIEF SUMMARY

By way of introduction, a data management system is disclosed that provides a system for managing data, such as product information data. The system allows vendors, such as manufacturers and representatives of the manufacturers, to enter, search and maintain the data. The data may include one or more text attributes and images related to a product associated with a vendor.

The data management system includes a database and one or more interfaces to allow vendors and buyers access the database. The buyers include individuals, suppliers, wholesalers, distributors and retailers that purchase the vendors' products. The data management system database stores the data describing a product. While vendors enter and maintain the product information data, final descriptions and modifications to the data, such as pricing information, may be authorized by the buyer before the change goes into effect. Buyers may utilize the data in the database to provide information to its customers about the products. To provide its customers with the information, the data may be used to produce catalogs or to provide the on-line, such as through the Internet.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The data management system can be better understood with reference to the following drawings and description. The components in the figures are not necessarily to scale, emphasis instead being placed upon illustrating the principles of the invention. Moreover, in the figures, like reference numerals designate corresponding parts throughout the different views. In the drawings:

FIG. 1 is a flowchart illustrating a warehouse items management interface in a data management system.

FIG. 2 is a flowchart illustrating an image management interface in the data management system.

FIG. 3 is a flowchart illustrating a change report management interface in the data management system.

FIG. 4 is a flowchart illustrating a relay item management interface in the data management system.

FIG. 5 is a block diagram illustrating a data management system architecture.

FIG. 6 illustrates an example of main menu access to the data management system.

FIG. 7 illustrates an example of various criteria vendors can select from while performing an item search in the data management system.

FIG. 8 illustrates an example of a product summary displayed when a user clicks on a view all items link in the data management system main menu.

FIG. 9 illustrates an example of a download item interface displayed when a user clicks on download all items link in the data management system main menu.

FIG. 10 illustrates an example of a set price change effective date interface displayed when a user clicks on set effective price dates link in the data management system main menu.

FIG. 11 illustrates an example of a price change interface displayed when a user clicks on the “$” link in the search results interface in FIG. 8.

FIG. 12 illustrates an example of an add item interface displayed when a user clicks on add individual items link in the data management system.

FIG. 13 illustrates an example of the file creation process utilized with the data management system.

FIG. 14 illustrates an example of the location selection prompt for the file download utilized with the data management system.

FIG. 15 illustrates an example of a CSV data file utilized with the data management system.

FIG. 16 illustrates an example of a help file utilized with the data management system.

FIG. 17 illustrates an example of a file upload interface utilized with the data management system.

FIG. 18 illustrates an example of an image library containing images utilized with the data management system.

FIG. 19 is a screen shot from an exemplary catalog produced with data stored and maintained in the data management system.

### DETAILED DESCRIPTION

The data management system provides access to a data management database containing data, for example, text and image information about a vendor's product. Personnel or operators of the data management system include any person performing a function on the data management system such as vendors and buyers. A vendor includes product manufacturers and representatives of the manufacturers. The data includes information about product pricing, the size of the product, the number of products available, and other information, such as product numbers, including buyer product number and universal product numbers. A buyer includes individuals, suppliers, wholesalers, distributors and retailers that purchase and/or supply the vendors' products, and/or analyses at least some of the data concerning the vendor's product.

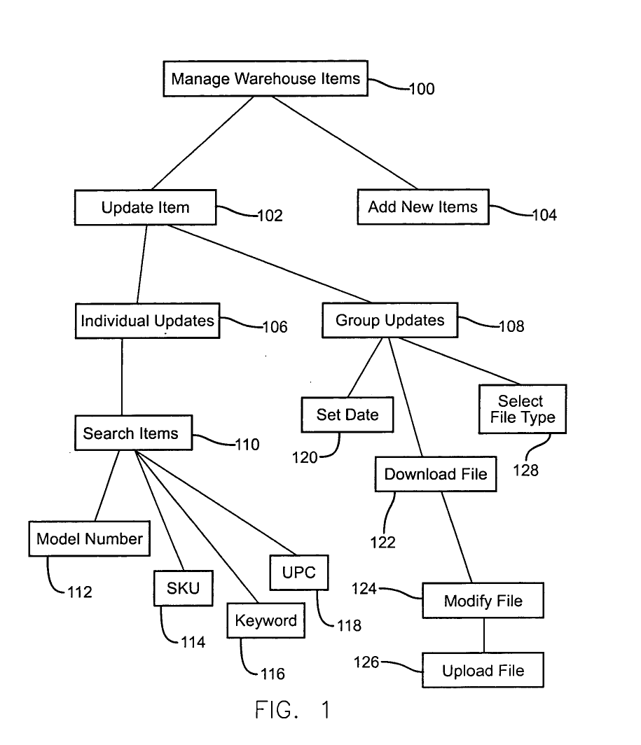

FIGS. 1-4 are flowcharts illustrating an exemplary navigation map of a data management system. FIG. 1 is a flowchart illustrating a warehouse items management interface navigation map in a data management system. The data management system may be divided into four options for a system vendor. At block 100, a vendor may use the data management system to manage database items either by updating the items in the database at block 102 or by adding new items at block 104. Vendors may update individual items at block 106 and/or perform group updates at block 108. Updates can be accomplished real time, using message triggers, or done on a regularly timed, download basis.

At block 110, before performing individual product updates, vendors may search for the items to be updated. Vendors may search a product in various ways such as by a product model number at block 112, by a stock keeping unit (sku) at block 114, or by other numbers associated with a product for inventory purposes. Furthermore, vendors may use other ways to search a product such as searching a product by a keyword at block 116, or searching by the universal product code (UPC) number, at block 118.

At block 108, under the group updates option, vendors can set price effective date for warehouse items associated with the vendor at block 120. Those skilled in the art will appreciate that the data management system may also be used to update the product prices individually. Vendors may also download a database file containing the vendor's products information at block 122. Vendors may modify the file at block 124, by performing operations on the file such as by suggesting an increase price for the items by a percentage, such as 5%, or in other ways, such as increasing the price by a dollar amount. Vendors may upload the modified file at block 126. Vendors may also select file types, such as EXCEL, ACCESS and Comma Separated, of the files to be downloaded for modification at block 128.

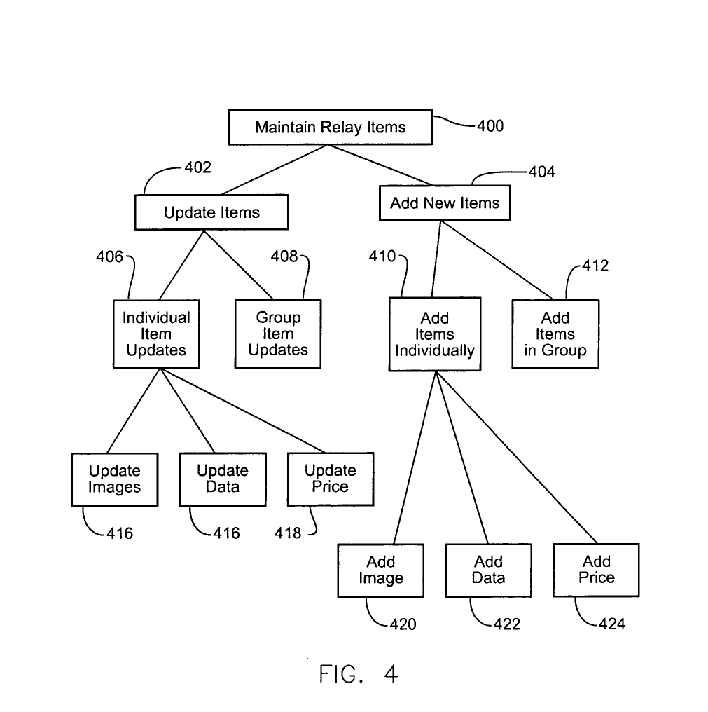

Vendors can add new items at block 104. The functionalities of add new items option at block 104 maybe same as the functionalities to add new items at block 404, which are discussed below with regard to FIG. 4.

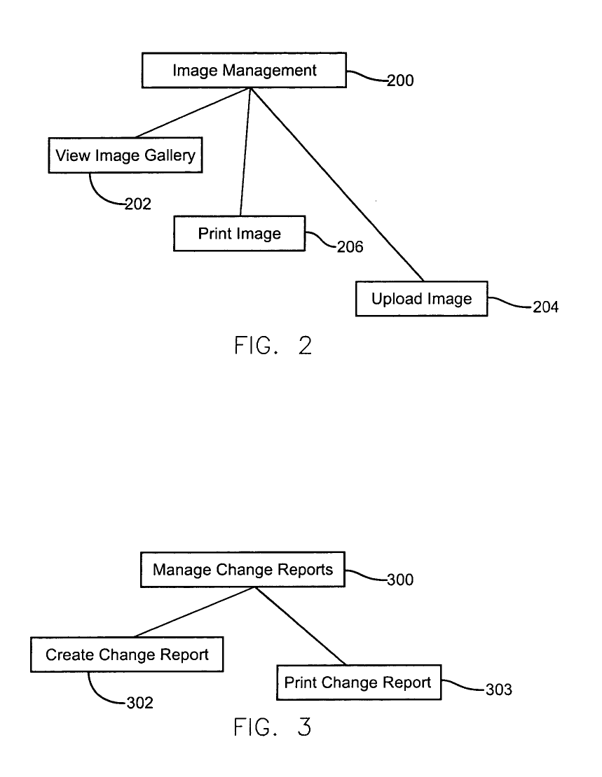

FIG. 2 is a flowchart illustrating an image management interface in the data management system. An image is a pictorial or graphic representation of a product. Vendors may use the data management system to manage product images. Under the manage images option at block 200, vendor can view an image gallery at block 202, upload product images at block 204, and print images at block 206.

FIG. 3 is a flowchart illustrating a change report management interface in the data management system. Under the manage change reports option at block 300, vendors can create a change report at block 302, and print a change report at block 303.

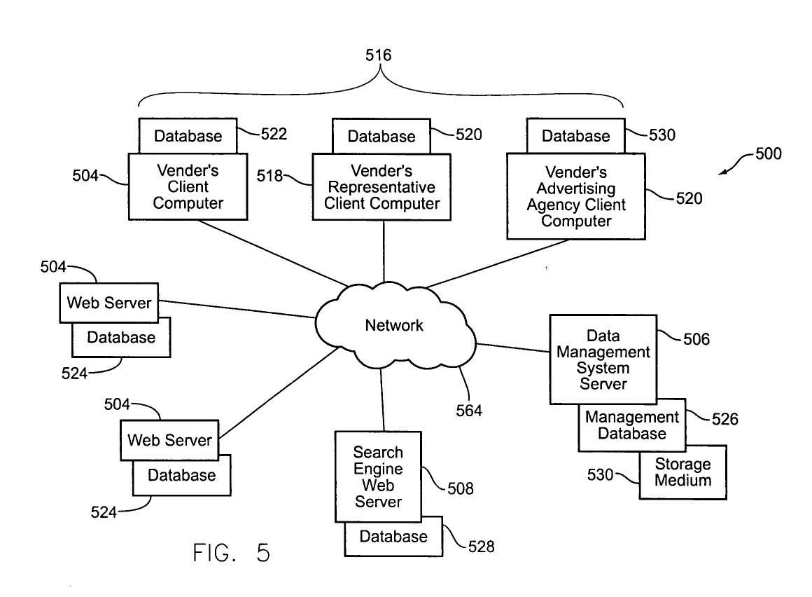

FIG. 4 is a flowchart illustrating a relay item management interface in the data management system. A relay item is an item that is purchased in bulk at a lower cost, but delivered in parts throughout a time interval, for example, up to one year. Vendors can maintain relay items at block 400. Using a standard retail program, buyers may purchase relay items in bulk for a lower price and receive a shipment of number of items for a time period. Vendors may update relay items at block 402 either by performing individual item updates at block 406. Under the individual item update, vendors may update a relay product image at block 414, product data at block 416 or product pricing at 418. Under the product image option vendors may update images associated with a particular item. Image updates can be accomplished individually or in bulk. Vendors may perform the updates of the individual product items, using an Internet enabled form as shown in FIG. 5.

Vendors may also choose to update a plurality of relay items by performing a group update at block 408. Furthermore, vendors may also add new relay items at block 404. Vendors may add new items individually at block 420, such as vendors may add new image of a relay item at block 420, add relay item data at block 422, and add price for a relay item at block 424. Vendor can update several relay items at once by performing a group item addition at block 412.

FIG. 5 is a block diagram illustrating an exemplary system architecture design of a data management system 500. FIG. 5 is an example of a distributed system configured as a client/server architecture. A client includes a member of a class or group that uses the services of another class or group to which it is not related. A server includes a remote computer system that maybe accessible over a communications medium such as the Internet.

The server maybe located remotely from the client. The client process may be active in a second computer system and communicate with the server process over a communications medium that allows multiple clients to utilize the information-gathering capabilities of the server. Thus, the server may act as an information provider for a computer network.

The data management system 500 may include a plurality of vendor web servers 504 and associated database 524, a data management system server 506 and associated database 526, and a search engine web server 508 and associated database 528. The data management system may also include a plurality of client computers such as a vendor's computer 514, computer of vendor's representative 518, or a computer of vendor's advertising agency 520 maybe connected to a network 564 such as the Internet. The vendor's computer 514, the computer of the vendor's representative 518, and the computer of vendor's advertising agency 520 are referred to as a client computer 516.

It should be understood that the client computers 516, vendor web servers 504, data management system server 506, and search engine web server 508 may be connected together through one of a number of different types of networks. Such networks may include local area networks (LANs), wide area networks (WANs), such as the Internet, and regional networks accessed over telephone lines, such as commercial information services. The client and server processes may even include different programs executing simultaneously on a single computer. Vendor web server 504, data management system server 506, and search engine web server 508 and their associated storage device include part of a data management system server product management system 502, as described herein.

The client computers 516 can include conventional personal computers (PCs), workstations, or computer systems of any other size. The client computer 516 typically include one or more processors, memories, input/output devices, and a network interface, such as a conventional modem or network interface card. The vendor web servers 504, data management system server 506, and the search engine web server 508 can be similarly configured. However, vendor web servers 504, data management system server 506, and search engine web server 508 may include many computers connected by a separate private network or Intranet.

The client computers 516 can execute web browser programs, such as the NAVIGATOR, EXPLORER, or MOSAIC browser programs, to locate the web pages or records stored on the data management system server 506. The browser programs allow the users to enter addresses of specific web pages to be retrieved. These addresses may include Uniform Resource Locators, or URLs. In addition, once a page has been retrieved, the browser programs can provide access to other pages or records when the user “clicks” on hyperlinks to other web pages. Such hyperlinks are located within the web pages and provide an automated way for the user to enter the URL of another page and to retrieve that page. The pages can be data records including as content plain textual information, or more complex digitally encoded multimedia content, such as software programs, graphics, audio signals, videos, and so forth.

Client computers 516 may communicate through the network with various network information providers, including data management system server 506, search engine server 508, and vendor servers 504 using the functionality provided by a HyperText Transfer Protocol (HTTP), although other communications protocols, such as FTP, SNMP, TELNET, and a number of other protocols known in the art, may be used. Search engine server 508, data management system server 506, and vendor servers 504 maybe located on the World Wide Web.

The data management system server 506 may include a computer storage medium 532 and a processing system. A database is stored on the storage medium 532 of the data management system server 506. The database contains vendor account information. It will be appreciated from the description below that the data management system described herein may be implemented in software that is stored as executable instructions on a computer storage medium, such as memories or mass storage devices, on the data management system server 506. The data management system 506 may also be implemented in other way such as with hardware and/or firmware. Conventional browser programs, running on client computers 516, may be used to access vendor account information stored on data management system server 506. Preferably, access to the data management system server 506 maybe accomplished through a firewall, not shown, which protects the account management and search result placement programs and the account information from external tampering. Additional security may be provided via enhancements to the standard communications protocols such as Secure HTTP or the Secure Sockets Layer.

Another server type contemplated includes a search engine web server 508. A search engine program permits network users, upon navigating to the search engine web server URL or sites on other web servers capable of submitting queries to the search engine web server 508 through their browser program, to type keyword queries to identify pages of interest among the millions of pages available on the World Wide Web. The search engine web server 508 generates a search result list that includes, at least in part, relevant entries obtained from and formatted by the results of the updates conducted by the data management system server 506. The search engine web server 508 generates a list of hypertext links to documents that contain information relevant to search terms entered by the user at the client computer 516. The search engine web server transmits this list, in the form of a web page, to the network user where it is displayed on the browser running on the client computer 516. One embodiment of the search engine web server may be found by navigating to the web page at the URL http://buyer.com/.

The data management system 500 provides vendors an access to a comprehensive database containing text based and image information. A plurality of client computers 516 such as an vendor's computer 514, computer of vendor's representative 518, or a computer of vendor's advertising agency 520 maybe given access to the vendor's data located in data management system server database 526 associated with the data management system server 506. The vendor may modify a vendor's copy of the data, for example, by changing a product attribute such as product price, product image, product description or other product data or by adding new products. At some point, the data contained in databases 522, 520, and 530 associated with client computers 516 could be synchronized with the data contained in database 526 associated with the data management server 506.

The data management server 506 periodically, or in real-time, determines whether databases 520, 522, and 530 are in synchronization with database 526. If a client computer modifies a product attribute such as product price, image or description etc., the client computer's copy of database goes out of sync with the data in the data management system database 526. Then the data management system 500 may be used to highlight the differences between the two datasets and to submit a change request for the data management system's management team.

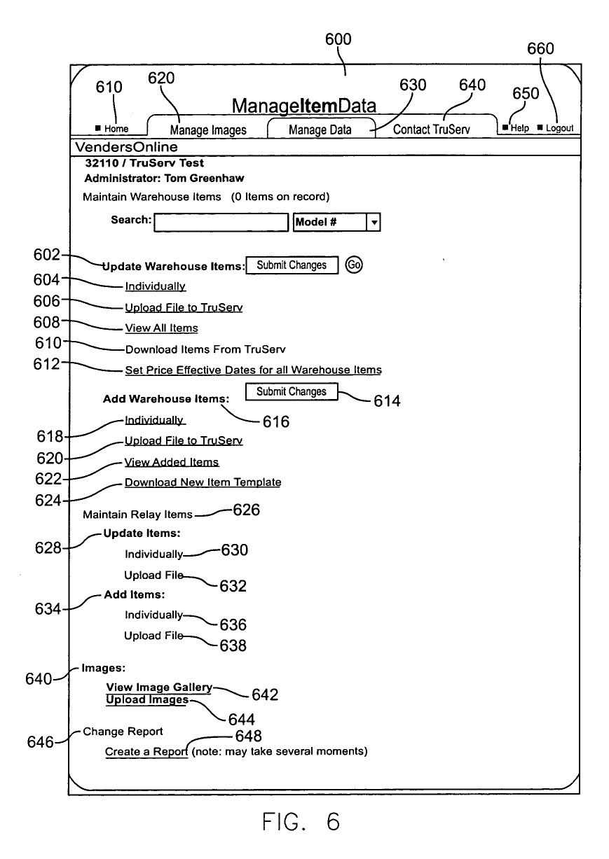

FIG. 6 illustrates an example main menu access to the data management system. The main menu 600 provides navigation to the areas of the database associated with the data management system, hereinafter referred to as a management database. The home button 610 returns vendors to a data management system home page. The manage images tab 620 provides access to an Image Gallery, where a vendor maybe given an access to all the images associated with the vendor. The manage data home tab 630 returns the user to the main menu from other sections of the data management system.

The contact tab 640 displays a list of contact information for qualified data management system personnel who can provide assistance with various aspects of the data management system. The help link 650 opens a window containing the data management system information, such as tips on finding an existing data, maintaining warehouse items, maintaining relay items, maintaining images, performing price changes, submitting change reports, and data item glossary. The Logout link 660 permits the user to conclude a session with the system.

FIG. 6 is an example of a buyer's interface to the data management system. The data management system may have a different login interface for a vendor, which may include some or all the links in the buyer's interface. Furthermore, the data management system vendor's interface may include additional fields such as the user's vendor number, user's name, and a download button for downloading the management database files. The interface may also contain a field displaying the user's total number of items in the management database, in real time.

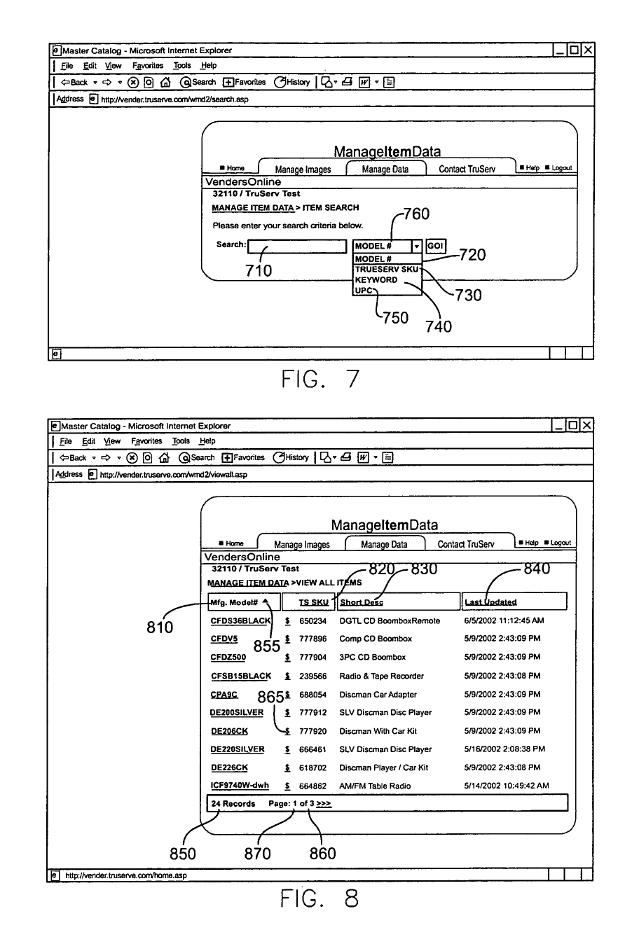

Vendors may update the product information by selecting an option under update warehouse items section 602. Vendors may view the items in the management database individually by clicking link individually 604. Vendors may select items to be updated by searching items by a search criterion. An example of a search is illustrated in FIG. 7, described below. Vendors may also click on a view all items link 608 in the main menu 600, which provides a summary of all the items recorded for the currently logged on vendor. An example of a summary is shown in FIG. 8, described below.

The data management system 600 may implement a secure design by providing a restricted access by the vendor to the product data. Even though vendors may have unlimited access to their own product data and images, the data management system 600 may not provide a vendor access to data and images of other vendors.

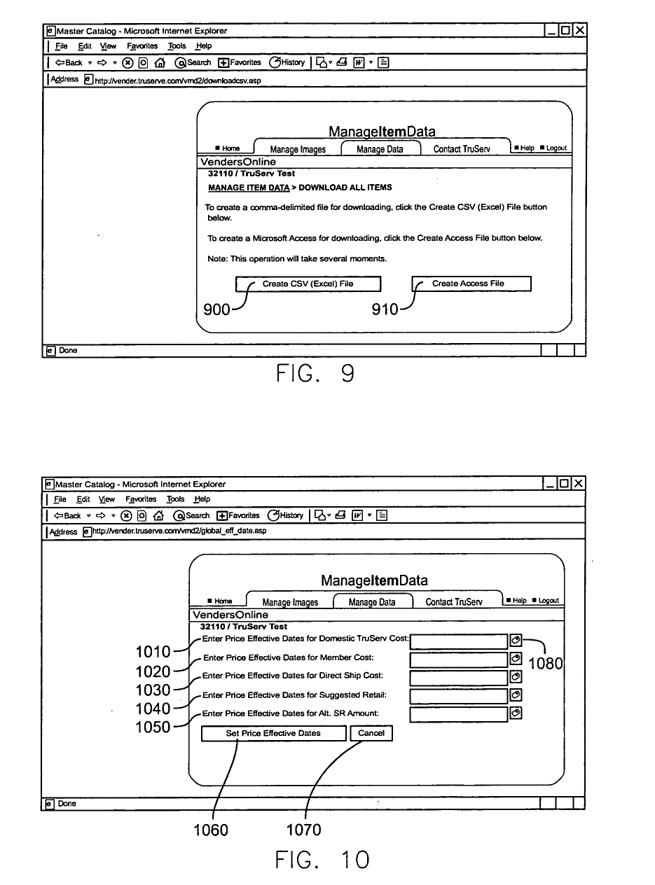

Vendors may also click on a download all items link 610 in the main menu 600, which provides a file download interface prompting the user to select a type of file to be downloaded. An example of a file download interface is shown in FIG. 9, described below. After downloading a file from the management database, a user, such as the vendor, may modify the file. In one example, the vendor may merely propose changes and the user proposed changes may not become effective until data management system personnel, such as the buyer, approves the changes. The user may upload the file to the management database by clicking on upload file link 606 in the main menu 600. An example of upload file interface is shown in FIG. 11. The user proposed changes may stay pending until the changes are approved by the buyer. If the user proposed changes are approved, the management database is updated to reflect the changes.

Furthermore vendors may click on a set price effective dates link 612 in the main menu 600, which provides a price effective date selection interface, which prompts the user to specify the dates when the user suggested price change would be effective. An example of a price effective date selection is shown in FIG. 10, described below.

Besides modifying the product data, vendors may also add a new item by clicking on add individual items link 618 in the main menu 600, which provides an add item interface where users can add details for a product. An example of a add product interface is shown in FIG. 12, described below.

FIG. 7 illustrates an example of various criteria vendors can select from while performing an item search in the data management system. The item search interface shown in FIG. 7 is displayed when the user clicks the update items individually link 604 in the main menu 600. Vendors may specify products to update by entering a value for a search criterion in the input text box 710, for example a vendor may perform a search by model number 123456. The drop down menu 760 allows vendors to select a search criterion. The data management system searches the management database for the specific product.

The drop down menu list 710 may include a model number 720, a sku 730, a keyword 740, and a UPC 750 option. Vendors can search for a product by selecting Model # option 720 from drop down list 760 and entering the product's model number 720, such as the manufacturer's model number in the text box 710. The model number is represented by maximum amount of characters such as 25 ASCII characters. Vendors can also search for a product by selecting a sku 730 from drop down menu list 760 and entering the sku 730, which is a code that uniquely identifies a product in the data management system database 526, in the text box 710. The data management system 600 uses a 6-digit long sku code and the data type of the code as an Integer. But other amounts of digits may be used for storing a sku 730 such as 4 or 8.

The data management system 600 can be used to accommodate various data standards, such as standard set by the Uniform Council, Inc. To accommodate a standard, rules may be set up for the fields to enter data into the database. The rules can be used to only accept data in certain formats. For example, the unit of measure 1 inch can be notated in many ways: 1 in., 1″, 1/12 ft., 1 inch, 1 nch, “one inch” etc. The database either converts the entered data into the proper form and/or informs the user of the proper form, such as by providing an error message that the data was not entered correctly. For example, if the sku number was entered with nine digits, and the sku number should be ten digits long, the user may be prompted to enter a ten digit number, not a nine digit number.

In addition to the field rules, rules may be set up at other levels. For example, program rules may be implemented such that the program recognizes that an entered UPC code is unique. In addition to the field rules and program rules, data may be accepted or rejected at the buyer's discretion. For example, the buyer may reject a proposed price change that the vendor tries to implement. The proposed price change may contradict a contract or other previous agreement between the buyer and the vendor. Likewise, the buyer may reject or edit a proposed change to the description of the vendor's product.

Vendors may search for a product in the data management system 600 by selecting an option keyword 740 from drop down menu list 760 and by entering a keyword 740 in the text box 710. The vendor specified keyword 740 is searched in product descriptions stored in the management database 526. The descriptions can be 50 characters long. However, descriptions longer than 50 characters can also be used. Vendors can also search for a product by selecting the UPC code option 750 from drop down menu list 760 and by specifying the product UPC code 750 in the text box 710. The data management system may use 14 decimal long UPC code however, UPC codes of various lengths can also be used.

FIG. 8 illustrates an example of a product summary displayed when a user clicks on a view all items link 608 in the main menu 600. The product details such as model number 810, sku 820, a short product description 830, and date of last product update 840 maybe displayed in a summary page. The summary can be sorted from any column by clicking on the summary heading. An up/down arrow symbol may appear in the sort column and can be clicked to reverse the order of the sort.

By clicking on a model number 810 vendors can open the product's complete detail screen, example of a product detail screen is illustrated in FIG. 12. At 850, the summary page displays total number of records associated with the logged in user in the management database 526. The current page 870 and total number of summary pages 860 are also displayed in the summary page. The > < links allow vendors to move forward or backward one page. The >> << links allow vendors to move to the beginning or end of the summary.

The last updated column 840 of the search result interface describes the date of last product update. As a fault tolerance feature, the data management system 500 accumulates and logs the update information such as name of the updated field, name of the person updating the field, and the original value before update.

This information is may be useful to locate any possible misuse of the data management system. In case of a dispute the feature may provide objective and reliable data that can help dispute resolution. For example, buyers may refuse certain update because an unauthorized person may be changing prices, and the feature helps understanding details associated with the fraudulent transaction.

The triangle symbol 855 located adjacent to model number 810 is a sorting tool. Each of the five columns can be sorted by clicking on the sorting tool. In FIG. 8 the unsorted columns 820, 840, and 850 have a hyperlink, when vendor clicks on the column heading, the sort tool 755 appears near the column. Once the column is sorted, the column heading hyperlink may disappear. The $ sign 865 represents pricing tool, details of the pricing tool are discussed in FIG. 11.

FIG. 9 illustrates an example of a download item interface displayed when vendors click on download all items link 610 in the data management system main menu 600. In addition to editing individual products online, vendors may select to perform group product update. As shown in FIG. 9 vendors may download a file containing all the records associated with the vendor from the data management system database 526. The data management system database may support various types of files downloads such as, a CSV (Comma Separated values) is a text file 900, which can be read by many computer systems, and a Microsoft Access 97 .MDB file format 910.

The first record in the CSV file contains the column headings of the data. The Microsoft Access.MDB format is compatible with the earlier method of providing data to buyers. Other file types may be supported such as .XDR, XSD, and .DTD. When either of the buttons 900 or 910 is pressed, the data management system may prepare a data file containing all the records associated with the vendor. When the file is created, a “Done” message maybe displayed to alert the vendors of the file creation.

FIG. 10 illustrates a set price effective date interface, which is displayed when the user clicks the set price effective dates link 612 in main menu 600. Vendors may enter price effective dates for domestic cost 1010, for member cost, which is cost per item charged by the buyer to a buyer member 1020, for direct shipping cost 1030, for retail cost 1040, and for the vendor's suggested retail amount 1050.

Vendors may click on the calendar tool 1080 which may open a new window displaying a calendar. The data management system forces the users to enter a date in the correct format. This feature may reduce the number of errors associated with entering a date. Vendors may click on the appropriate dates to select effective dates for a price change and click on button the set price effective dates 1060 to submit the dates to the management database 526. Vendors may also click on button 1070 to abort the changes.

FIG. 11 illustrates an example of a price change interface displayed when a user clicks on the “$” link in the search results interface in FIG. 8. The price change interface provides a way of viewing and analyzing product pricing. The header 1100 contains the relevant product information such as product description, model number, and sku. The header 1100 also contains name of a buying department, which represents the department responsible for purchasing the product. The header 1100 also enumerates a fineline department, which represents a buyer retail fineline department code. The data management system stores the buying department and fineline department in two character long ASCII code.

A product value is enumerated in column 1110. The pricing tool may automatically calculate the margin percentage 1120 for the current product pricing and the proposed product pricing. The unit of measure code, UOM for a product is listed in column 1130. Effective date is a date on which the new prices for a product listed under column 1140 would become effective. The price change interface lists the current price and the proposed price in editable text boxes. When proposed changes are made and not yet accepted, they may be highlighted in red. Additionally vendor can roll back from the proposed updates back to the current price using the roll back button 1160. When selecting dates for effecting the price change, a convenient calendar date selection tool 1150 may be provided. The calendar tool 1150 provides a way of assuring a uniform vendor input and avoids errors associated with entering a date, for example some vendors may enter date as 1/1/2003 others may enter it as 1-1-2003, and yet others may enter it as 1^{st} Jan. 2003.

The Buyer cost 1165 is cost per item charged to the buyer. The direct shipping cost 1180 may be calculated against the member cost 1175. The member cost 1175 may be calculated against the suggested retail price 1185. A competitor price 1195 for a similar product may be displayed in the price change interface. This feature may be useful for vendors since vendors can have an idea of the competitor prices while they set their own prices. This may help vendors adjust their prices accordingly. If the competitors prices are very high then a vendor may lower the product price, however if the competitor has very high price then a vendor may raise the product price.

FIG. 12 illustrates an example of add item interface displayed when a user clicks on add individual items link 618 in main menu 600. A vendor may perform product updates either by updating attributes of an individual product using an Internet enabled form as shown in FIG. 12 or by adding new items. Some of the product properties are displayed in this interface. A vendor may edit any of the input text fields using interface.

The Item detail interface may be divided into the six sections. The first section may be product detail section represented by numeral 1200. Under this section, vendor may update item price change effective date via a calendar 1202, product model number 1203, UPC code 1204, Buying department purchasing the product 1205, short description 1206, long description 1208, or discontinue the product at 1207. As changes are made to product information, the changes maybe highlighted in red and the current state of the buyer's data may be displayed. A roll back change button 1209 may be provided to revert any undesired changes on a case-by-case basis. An Item Change History button 1201 allows the vendor to review all the changes made to a product using this system.

Another section in the item detail interface may be product pricing section denoted by numeral 1210. The details of the fields under this section are included in FIG. 11. Yet another section of the item detail interface may be product information section represented by 1220. The next section of the item detail interface may be the pack information section represented by numeral 1230. Buyer specific product Information section of the item detail interface may be represented by numeral 1240. The changes may be saved when the “Update Item” button 1260 may be pressed. When a vendor enters values in the item detail interface and clicks on update item button 1260 the updates made by the vendor are submitted to the data management system database.

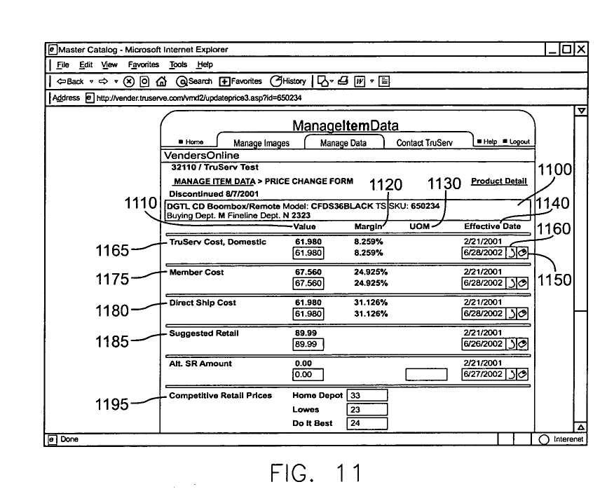

FIG. 13 illustrates an example of the file creation summary display in the data management system. Details of the file creation process are shown in FIG. 6. The vendor may press the hyperlink 1300 to access the data file created the database management system.

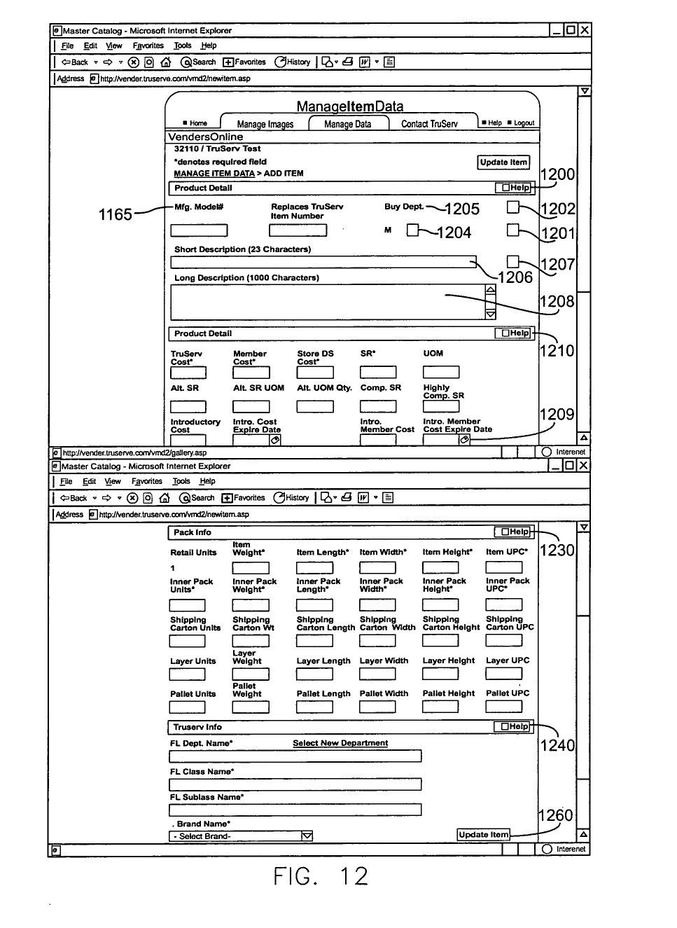

FIG. 14 illustrates an example of the location selection prompt for the file download in the data management system. The data management system prompts the vendor to choose the location on the vendor computer where the data file to be saved. The vendor may click on save this file option 1410 to save the file on the vendor computer. The vendor also has an option 1400 of opening the file directly into the vendor's web browser. Support for “Open this file from its current location” may depend upon the vendor's proper configuration of software such as Microsoft Excel® and Microsoft Access®).

FIG. 15 illustrates an example of a CSV data file in the data management system.

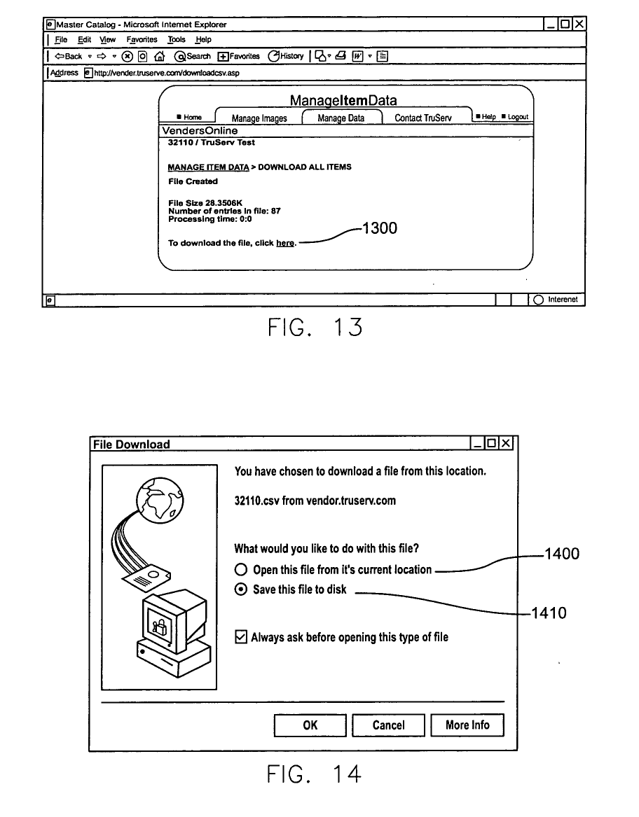

FIG. 16 illustrates an example of a help file in the data management system.

FIG. 17 displays upload interface for a Microsoft Access .MDB file. Upon modifying the database file a vendor can upload the file by specifying the file path in the input text box 1700, and clicking on upload file button 1710. The vendor may press the Browse button to locate the Getbatch.mdb file on vendor's local computer system. Once the file is selected the Upload button will send the updated file to the data management system data base number. After being uploaded, the file's contents will be placed in a queue for data management system's management personnel. Progress of upload process may be shown, and when the upload process is complete, the vendor may be returned to the main Menu.

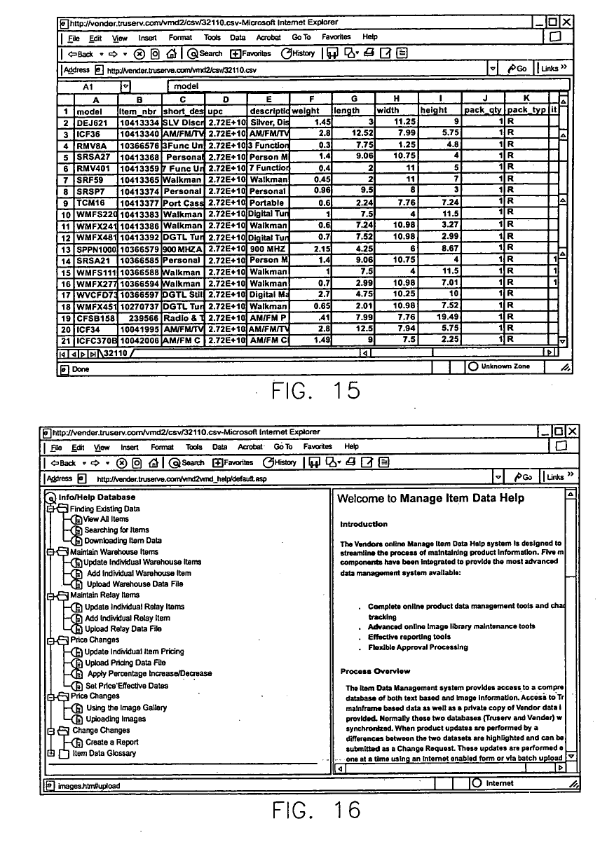

FIG. 18 illustrates an example of image library in the data management system. Vendors may access the image library by clicking on view image gallery hyperlink. Included with this system may be an easy to use image library maintenance tool number. The tool may be accessed by clicking the “View Image Gallery” link in the Images section of the main menu 600. The image library shown in the gallery may be separate and independent from data management system image library. The image gallery may be designed to provide data management system vendor with a convenient place to manage images, associate images with buyer sku numbers, and submission for updating data management system image library.

Images that have been uploaded to the system may be shown in the gallery. These images are shown in pages with one or more images to a page. At the bottom of the gallery screen are tools for navigating the pages within the image gallery. The gallery screen may include a tool searching for image names in the gallery. The “*” is a wildcard character and can be used to help filter the images shown in the gallery. The images can be shown in ascending or descending order. The images include line art images, such as a black and white line image, and color images.

Images may be contained within its own picture box. The picture box may include buttons for controlling the editing functions of an image. A button shown here with a picture of a disk may be used to save any changes made to the editable text areas associated with each image. The images can be saved in any format, such as TIFF, JPEG, or another format, such as MS Word. Another button, shown here with an up arrow may be used to upload new images. A button, shown here with an “X” symbol, may be used to delete an image.

The images shown in the gallery may not be shown at actual size, they may be scaled to fit with the gallery display box. Image size details may be shown at the in the image's display box. Images can be associated with buyers' sku numbers and other information, such as a UPC number. Vendors can associate any number of images to a buyer's sku number. Additionally, vendors can associate an image with multiple sku numbers, for example, by entering these sku numbers separated by a comma.

The data management system 600 may also be used to provide the vendor's advertising agent access to vendor's images. This may be helpful because vendor's advertising agent may upload the image and instantly check if one of the images stands out or does not confirm with other images. Managing product data in flux may be easier for vendors since vendors can experiment with the images and perform analysis of the market impact of a product advertising profile on the business and product sale.

Conveying the product information using the data management system 600 can be an effective and timely for the vendors to gain a first hand view of a product image as seen by the buyer. Images can then be updated as frequently as needed. Additionally, a gap may be eliminated between the time a vendor dispatches an image or product information and the time the information is published in the catalog.

FIG. 19 is a screen shot from an exemplary catalog produced with data stored and maintained in the data management system 600. The data can be used to produce electronic or paper catalogs. The catalogs can be accessed via the Internet, sent to customer via electronic-mail, and/or mailed to customers as paper copies. Vendors can produce catalogs using the data as can buyers. It can be appreciated that the vendors would probably produce catalogs containing only its products, while the buyers could produce catalogs containing a variety of vendors' products.

While typical publishing of catalogues can be expensive, the data management system 600 can be used to print catalogues without causing additional overhead to users. Therefore, industries may not have to allocate as large a portion of their fiscal budget for printing the catalogues.

While various embodiments of the invention have been described, it will be apparent to those of ordinary skill in the art that may more embodiments and implementations are possible that are within the scope of the invention.

We claim:

1. A data management system, comprising:
a database to store data; and
at least one interface to access the database, where a plurality of vendors access the database via the interface to enter and maintain the data.

2. A data management system, comprising:
at least one database to store data;
at least one interface to access the database, where a plurality of vendors are able to access the database via the interface to at least one of view data and submit a change of data request; and
wherein a buyer reviews the change of data request and determines whether to update the database in accordance the change of data request.

3. The data management system of claim 2 wherein the data comprises data describing a product.

4. The data management system of claim 2 wherein the vendors comprise at least one of manufacturers and representatives of the manufacturers.

5. The data management system of claim 2 wherein the data is used to create catalogs.

6. The data management system of claim 5 wherein the catalog comprises an on-line catalog.

7. The data management system of claim 2 wherein the data is used to provide product information on-line.

8. The data management system of claim 2 wherein the database comprises a vendor database and a data management database.

9. The data management system of claim 8 wherein the vender is able to change data contained in the vendor database.

10. The data management system of claim 9 wherein data contained in the vendor database is able to be compared with data contained in the data management database.

11. The data management system of claim 10 wherein differences can be displayed between data contained in the vendor database and data contained in the data management database.

12. The data management system of claim 11 wherein the data contained in the data management database is capable of being changed in accordance with the differences.

13. The data management system of claim 2 wherein the buyers comprise at least one of wholesalers, distributors and retailers.

14. A method for managing data contained in a database, comprising:
storing data in at least one database;
providing a plurality of vendors access to the at least one database via an interface to at least one of view the data and submit a change of data request; and
a buyer reviewing the change of data request; and
the buyer determining whether to update the at least one database in accordance with the change of data request.

15. The method of claim 14 wherein the data comprises data describing a product.

16. The method of claim 14 wherein the vendors comprise at least one of manufacturers and representatives of the manufacturers.

17. The method of claim 14 further including creating catalogs with the data.

18. The method of claim 17 wherein the catalogs comprise on-line catalogs.

19. The method of claim 14 further including providing product information on-line with the data.

20. The method of claim 14 wherein the database comprises a vendor database and a data management database.

21. The method of claim 20 further including changing data contained in the vendor database.

22. The method of claim 21 further including comparing data contained in the vendor database with data contained in the data management database.

23. The method of claim 22 further including displaying differences between data contained in the vendor database and data contained in the data management database.

24. The method of claim 23 changing the data contained in the data management database in accordance with the differences.

25. The method of claim 14 wherein the buyers comprise at least one of wholesalers, distributors and retailers.
